(19) United States
(12) Patent Application Publication
(10) Pub. No.: US 2010/0061008 A1
(43) Pub. Date: Mar. 11, 2010

(54) MAGNETIC DISK DRIVE

(75) Inventors: Masaharu Moritsugu, Kawasaki (JP); Nozomu Okazaki, Kawasaki (JP); Hiroki Matsushita, Kawasaki (JP); Takehiko Katoh, Kawasaki (JP); Tsuneki Takahashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/505,945

(22) Filed: Jul. 20, 2009

(30) Foreign Application Priority Data
Sep. 9, 2008 (JP) 2008-230605

(51) Int. Cl. G11B 19/02

(52) U.S. Cl. 360/69; G9B/19.001

(57) ABSTRACT

A magnetic disk drive includes a switching regulator configured to generate an output voltage, and a magnetic disk control unit that receives the output voltage as a power supply and performs data write and read operations on a magnetic recording medium. The switching regulator includes a voltage conversion part configured to generate a second voltage by switching a first voltage, a smoothing part configured to smooth the second voltage to thus produce an output voltage, a control part configured to control the switching on the basis of a difference between the output voltage and a reference voltage to thus stabilize the output voltage, and a reference voltage changing part configured to change the reference voltage in accordance with an operation mode of the magnetic disk control unit.

### CROSS-REFERENCE TO RELATED APPLICATION

This application is based upon and claims the benefit of priority of the prior Japanese Patent Application No. 2008-230605, filed on Sep. 9, 2008, the entire contents of which are incorporated herein by reference.

### FIELD

A certain aspect of the embodiments discussed herein relates to a magnetic disk drive.

### BACKGROUND

Recently, the magnetic disk drives have remarkable improvements in the recording density and transfer speed. In addition, the magnetic disk drives have been functionally enriched. For example, functions of encoding and error correction may be implemented by hardware. Adversely, the improvements in performance of the magnetic disk drives tend to increase current consumption. Thus, there is an activity in shrinking LSI by downsizing the chip and improving the manufacturing process. In information processing apparatus such as personal computers, there is a proposal to change the frequency of the operating clock and the operating voltage in accordance with operation modes (see Japanese Laid-Open Patent Publication No. 5-11897, for example).

The shrinking of LSI and improvements in the manufacturing process considerably reduce the current consumption when the magnetic disk drive is active, but causes a problem such that a leakage current increases when the magnetic disk drive is inactive in a standby mode or a sleep mode. FIG. 1 is a graph of leakage current vs. operable drive voltage characteristics of a conventional process and an improved process.

The leakage current may be a source-drain current of a MOSFET (Metal Oxide Semiconductor Field Effect Transistor) used to form a controller in an SoC (System on a Chip). As illustrated in FIG. 2, the leakage current greatly depends on the drive voltage. The data transfer speed at which data is written in or read from the magnetic disk drive is proportional to the drive voltage supplied to the controller. Thus, there is a disadvantage in which the leakage current increases as the data transfer speed rises. Particularly, magnetic disk drives suitably used for portable computers spend much of time in the standby or sleep mode. Thus, the leakage current affects the lifetime of the battery installed in the portable computer.

### SUMMARY

According to an aspect of the present invention, there is provided a magnetic disk drive including: a switching regulator configured to generate an output voltage; and a magnetic disk control unit that receives the output voltage as a power supply and performs data write and read operations on a magnetic recording medium, the switching regulator including: a voltage conversion part configured to generate a second voltage by switching a first voltage; a smoothing part configured to smooth the second voltage to thus produce an output voltage; a control part configured to control the switching on the basis of a difference between the output voltage and a reference voltage to thus stabilize the output voltage; and a reference voltage changing part configured to change the reference voltage in accordance with an operation mode of the magnetic disk control unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a graph of leakage current vs. operable drive voltage characteristics of magnetic disk drives manufactured by different processes;

FIG. 2 is a block diagram of a magnetic disk drive in accordance with an embodiment;

FIG. 3 is a circuit diagram of a switching regulator used in the magnetic disk drive illustrated in FIG. 2;

FIG. 4 illustrates operation modes of the magnetic disk drive; and

FIG. 5 is a block diagram of a variation of the magnetic disk drive illustrated in FIG. 2.

### DESCRIPTION OF EMBODIMENTS

A description will now be given, with reference to the accompanying drawings, of embodiments of the invention.

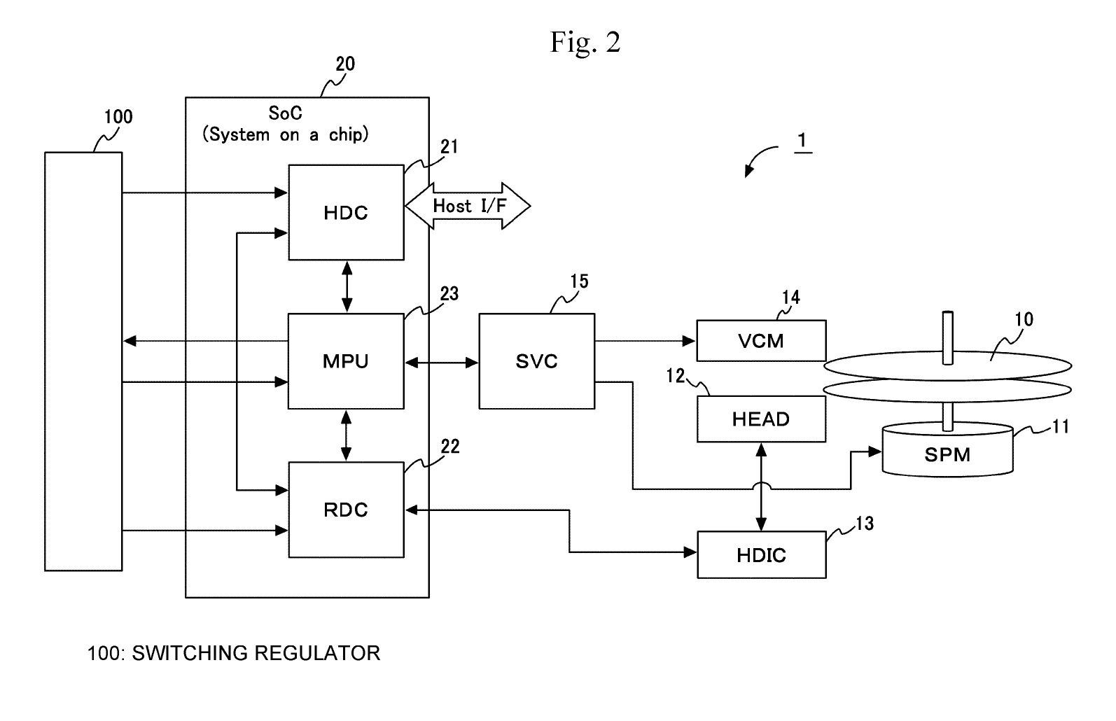

FIG. 2 is a block diagram of a magnetic disk drive 1 in accordance with an embodiment. The magnetic disk drive 1 has magnetic disks 10, a spindle motor (SPM) 11, magnetic heads 12, a head IC (HDIC) 13, a voice coil motor (VCM) 14, a servo control circuit (SVC) 15, a SoC 20, and a switching regulator 100. The magnetic disks 10 are disk-shaped recording media. The magnetic heads 12 write and read data in and from the magnetic disks 10. The head IC 13 controls the operations of the magnetic heads 12. The voice coil motor 14 moves the magnetic heads 12 over the magnetic disks 10 to execute the seek operation. The servo control circuit 15 controls the voice coil motor 14 and the spindle motor 11. The SoC 20 functions as a magnetic disk control unit, and drives the spindle motor 11 and the voice coil motor 14. The switching regulator 100 functions as a drive voltage supply unit.

The SoC 20 includes a hard disk controller (HDC) 21, a read/write channel (RDC) 22, and a microprocessor unit (MPU) 23.

The hard disk controller 21 may include an error correction circuit, a buffer control circuit, a cache control circuit and an interface control circuit, and executes a read/write control.

The read/write channel 22 may be equipped with a modulation circuit used for writing data in the magnetic disks 10, a parallel-to-serial conversion circuit that converts write data into serial data, and a demodulation circuit used to read data from the magnetic disks 10. The read/write channel 22 sends and receives data (signal) to and from the head IC 13. The head IC 13 switches the polarity of current to be supplied to the magnetic heads 12 in accordance with write data, so that write data can be recorded on the magnetic disks 10. The head IC 13 outputs read data reproduced by the magnetic heads 12 to the read/write channel 22.

The MPU 23 is involved in the overall control of the magnetic disk drive 1. More specifically, the MPU 23 may perform head positioning control, interface control, initializing and setting of peripheral LSIs, and defect management.

The switching regulator 100 steps down a power supply voltage from an external power source, and supplies parts of the SoC 20 with internal voltages thus produced. Particularly, the switching regulator 100 changes the voltage to be supplied to the SoC 20 in accordance with the operation mode of the SoC 20.

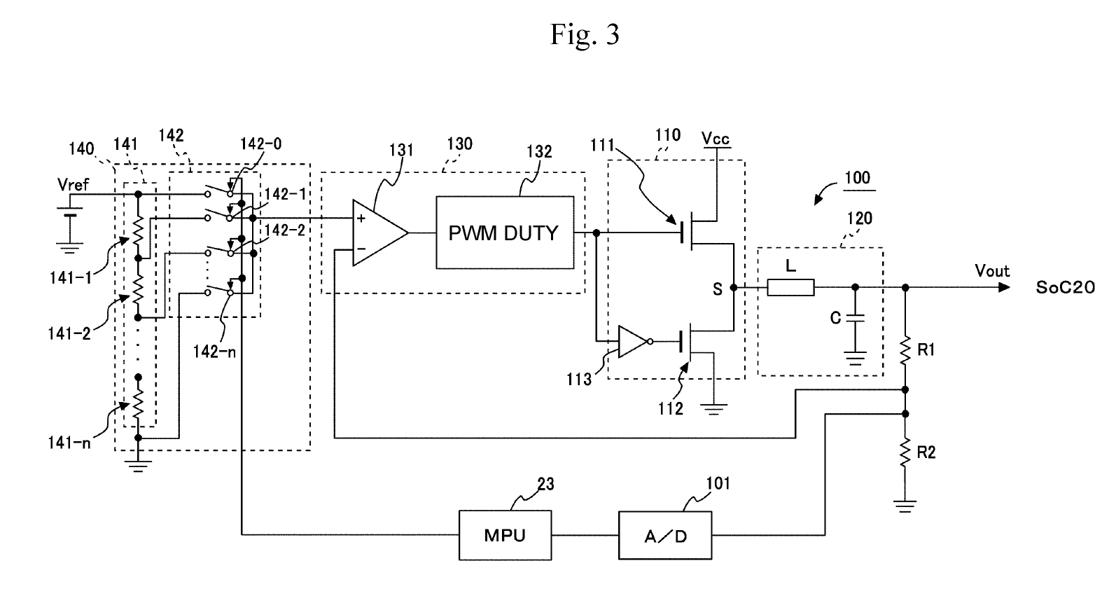

FIG. 3 is a circuit diagram of the switching regulator 100. As illustrated in FIG. 3, the switching regulator 100 includes a voltage conversion unit 110, a smoothing unit 120, a control unit 130, voltage dividing resistors R1 and R2, and a reference voltage changing unit 140.

The voltage conversion unit 110 includes MOS transistors 111 and 112, and an inverter 113. The MOS transistors 111 and 112 are connected in series, and are connected between an input power source Vcc and ground. The gate terminal of the MOS transistor 111 receives a PWM (pulse width modulation) signal from the control unit 130. The gate terminal of the MOS transistor 112 receives a signal obtained by inverting the PWM signal by the inverter 113. Thus, the MOS transistors 111 and 112 are turned ON and OFF in turn. The voltage conversion unit 110 produces a voltage (second voltage) by switching the power supply voltage (first voltage) Vcc in response to the PWM signal.

The smoothing unit 120 includes an inductor L and a smoothing capacitor C. The inductor L and the capacitor C of the smoothing unit 120 smooth the voltage (second voltage) of a node at which the MOS transistors 111 and 112 are connected, and outputs a smoothed output voltage Vout to the SoC 20. The output voltage Vout is a drive voltage supplied to the SoC 20. The switching regulator 100 is designed to control the output voltage Vout with a ratio of a time when the input voltage Vcc is being applied to the inductor L and the capacitor C to a time when the input voltage Vcc is not applied, in other words, the ON/OFF duty ratio of the MOS transistors 111 and 112.

The control unit 130 includes a comparator 131 and a PWM duty controller 132. The comparator 131 receives a voltage defined by dividing the output voltage Vout by the resistors R1 and R2 through an inverting input terminal. This divided voltage will be hereinafter referred to as a proportional voltage. The comparator 131 receives a reference voltage generated by the reference voltage changing unit 140 through a non-inverting input terminal. The comparator 131 detects the difference between the reference voltage and the proportional voltage and amplifies the difference. The output of the comparator 131 is applied to the PWM duty controller 132.

The PWM duty controller 132 produces the PWM signal having a duty ratio that depends on the output voltage of the comparator 131. That is, the PWM duty controller 132 controls the duty ratio of the PWM signal used to drive the MOS transistors 111 and 112 so as to depend on the difference between the reference voltage and the proportional voltage.

The reference voltage changing unit 140 includes a resistor section 141 and a switch section 142. The resistor section 141 has multiple resistors 141-1, 141-2, . . . , 141-n (n is a natural number) connected in series between the reference voltage Vref and ground. The switch section 142 has multiple switches 142-0, 142-1, . . . , 142-n.

The reference voltage changing unit 140 is supplied with the reference voltage Vref. The reference voltage changing unit 140 selects resistors for dividing the reference voltage Vref by switching the ON/OFF states of the switch section 142. For example, when the switch 142-1 is turned ON, the resistor 141-1 is selected to divide the reference voltage Vref. Similarly, when the switch 142-2 is turned ON, the resistors 141-1 and 141-2 are selected to divide the reference voltage Vref. The reference voltage generated by dividing the reference voltage Vref by the resistor section 141 is applied to the non-inverting input terminal of the comparator 131.

The ON/OFF switching of the switches 142-0, 142-1, . . . , 142-n is carried out by the MPU 23. More particularly, the MPU 23 receives a digital signal obtained by digitizing, through an A/D converter 101, the proportional voltage obtained by dividing the output voltage Vout by the voltage dividing resistors R1 and R2. The MPU 23 is supplied with a command of the operation mode of the magnetic disk drive 1 from an upper or host device via the hard disk controller 21 illustrated in FIG. 2. The MPU 23 receives the command of the operation mode from the upper device, and switches the ON/OFF states of the switch section 142 so as to obtain the output voltage associated with the instructed operation mode.

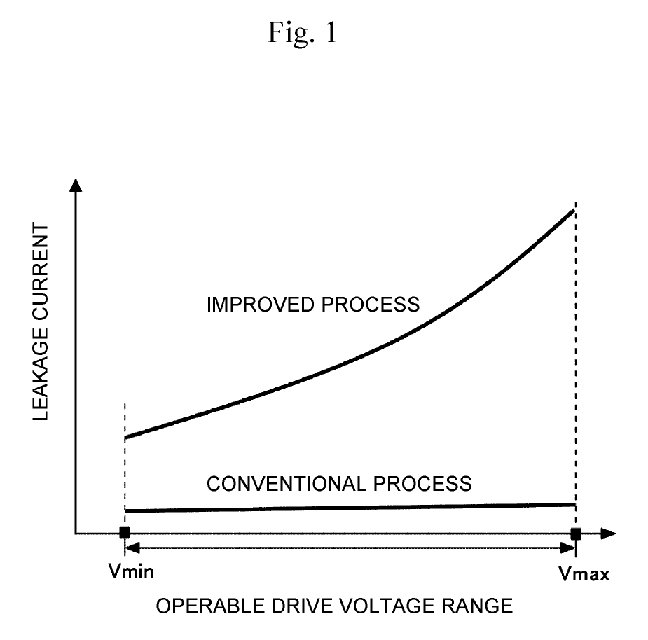

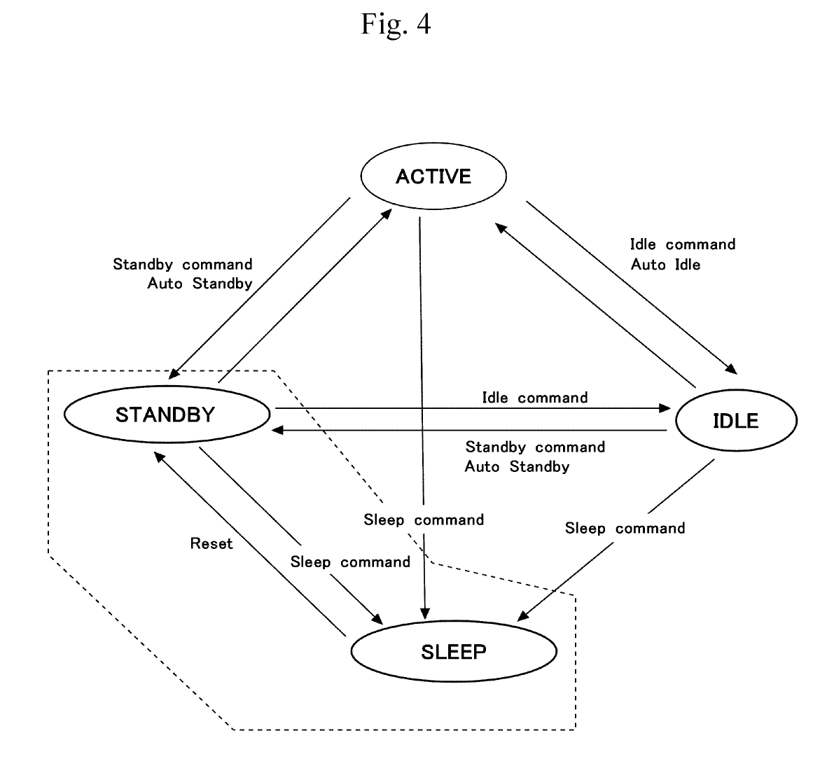

FIG. 4 illustrates operation modes of the magnetic disk drive 1. As illustrated in FIG. 4, the magnetic disk drive 1 has four operation modes of “active”, “idle”, “standby” and “sleep”. When the magnetic disk drive 1 is in an inactive mode, which is either the standby mode or the sleep mode, the MPU 23 switches the ON/OFF states of the switch section 142 so that the output voltage Vout becomes close to the minimum voltage of the operable drive voltage range shown in FIG. 1.

The switching of the switch section 142 by the MPU 23 is stepwise carried out. For instance, it is now assumed that the operation mode of the magnetic disk drive 1 changes from the active mode to the standby mode or sleep mode. The MPU 23 gradually increases the number of resistors of the resistor section 141 used for dividing the reference voltage Vref to thus gradually reduce the reference voltage, while referring to the proportional voltage from the A/D converter 101 and stabilizing the output voltage Vout. The control unit 130 refers to the reference voltage output by the reference voltage changing unit 140, and changes the duty ratio of the PWM signal so that the proportional voltage becomes equal to the reference voltage. By gradually reducing the reference voltage Vref by the MPU 23, the output voltage Vout is gradually reduced. For example, the MPU 23 controls the output voltage Vout at intervals of 0.05 V (50 mV) so that the output voltage Vout can be stepwise changed like 1.05 V→1.0 V→0.95 V.

According to the present embodiment, the voltage Vout supplied to the SoC 20 is reduced to a voltage close to the minimum voltage of the operable drive voltage range when the magnetic disk drive 1 is in the inactive mode such as the standby mode or the sleep mode. It is thus possible to reduce the leakage current in the inactive mode of the magnetic disk drive 1.

The resistors to be used for dividing the reference voltage Vref are switched by the switch section 140 while the output voltage Vout of the switching regulator 100 is monitored by the MPU 23. It is thus possible to generate the reference voltage used to cause the output voltage Vout of the switching regulator 100 to be close to the target voltage, which may be close to the minimum voltage of the operable drive voltage range. Thus, there is no need to precisely generate the reference voltage Vref that depends on the operation mode of the magnetic disk drive 1 outside of the switching regulator 100. It is thus possible to reduce the cost of the magnetic disk drive 1 and improve the production yield.

For example, in a 150 nm process, the leakage current may be 80 mA for a drive voltage of 1.25 V when the magnetic disk drive 1 is in the active mode. Thus, the power consumption is 0.1 W. The present embodiment changes the drive voltage to 1.0 V, and reduces the leakage current to 20 mA in the standby mode or sleep mode. Thus, the power consumption is 0.02 W. The power consumption in the standby or sleep mode is reduced to ⅕ of that in the active mode.

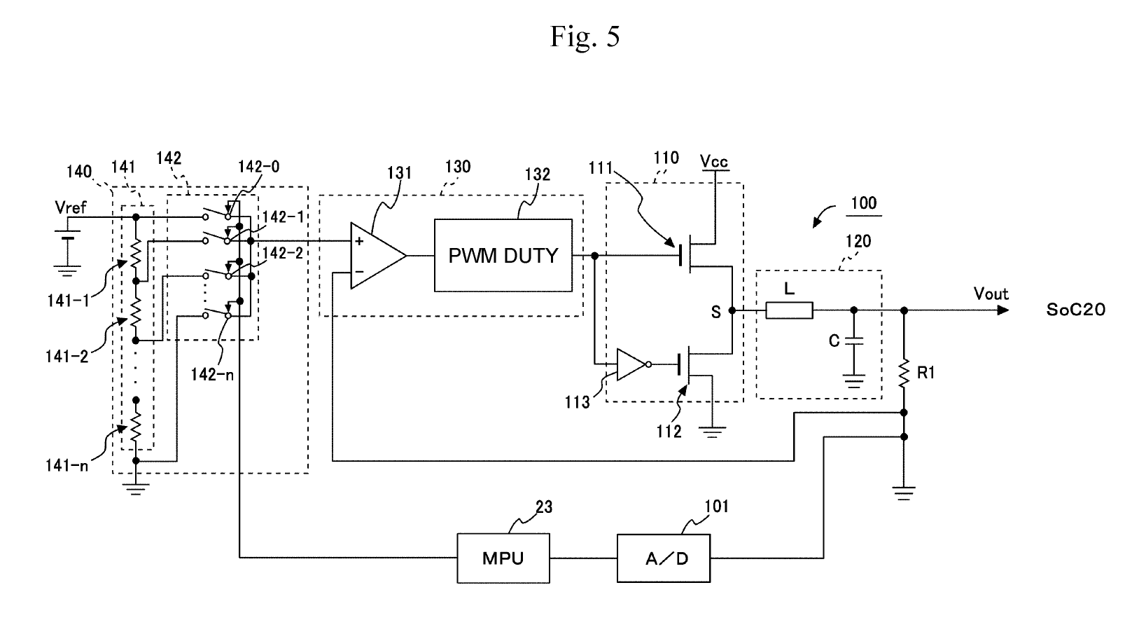

The configuration illustrated in FIG. 3 may be changed as illustrated in FIG. 5, in which only the resistor R1 is used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A magnetic disk drive comprising:
a switching regulator configured to generate an output voltage; and
a magnetic disk control unit that receives the output voltage as a power supply and performs data write and read operations on a magnetic recording medium,
the switching regulator including:
a voltage conversion part configured to generate a second voltage by switching a first voltage;
a smoothing part configured to smooth the second voltage to thus produce an output voltage;
a control part configured to control the switching on the basis of a difference between the output voltage and a reference voltage to thus stabilize the output voltage; and
a reference voltage changing part configured to change the reference voltage in accordance with an operation mode of the magnetic disk control unit.

2. The magnetic disk drive according to claim 1, wherein the reference voltage changing part changes the reference voltage so that the output voltage is close to a minimum voltage of an operable voltage rage of the magnetic disk control unit when the magnetic disk control unit is in an inactive mode.

3. The magnetic disk drive according to claim 1, wherein the reference voltage changing part includes:
a resistor section having multiple resistors connected in series;
a switch section that selects one or more resistors to be used to divide the reference voltage from among the multiple resistors; and
a control section that detects the output voltage and controls the switch section on the basis of the output voltage thus detected.

4. The magnetic disk drive according to claim 2, wherein the reference voltage changing part includes:
a resistor section having multiple resistors connected in series;
a switch section that selects one or more resistors to be used to divide the reference voltage from among the multiple resistors; and
a control section that detects the output voltage and controls the switch section on the basis of the output voltage thus detected.
